(19) United States
(12) Patent Application Publication
(10) Pub. No.: US 2009/0188957 A1
(43) Pub. Date: Jul. 30, 2009

(54) OUTRIGGER FOR USE IN SURVEYING APPLICATIONS

(76) Inventor: BRIAN P. MARTIN, Tustin, CA (US)

Correspondence Address: STETINA BRUNDA GARRED & BRUCKER, 75 ENTERPRISE, SUITE 250, ALISO VIEJO, CA, 92656, US

(21) Appl. No.: 12/416,398

(22) Filed: Apr. 1, 2009

Related U.S. Application Data
(63) Continuation of application No. 11/093,967, filed on Mar. 30, 2005.

(51) Int. Cl. B60R 9/00

(52) U.S. Cl. 224/402

(57) ABSTRACT

An outrigger attached to the side of a truck for carrying surveying rods from location to location without disassembly. The outrigger utilizes a standard stake pocket on the bed of the truck and a bungee cord hooking to the underside of the truck chassis. The surveying rods are supported on the outrigger through a receiver plate with a hole where a section of the stake of the surveying rod may be inserted, and a quick release rubber clamp at its highest point. In the middle are plates partially enclosing the surveying rod, and complete enclosure is achieved by way of an insertable wire lock pin.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Technical Field

The present invention relates to side-mounted outrigger devices for holding surveying instrumentation, namely, G.P.S. and prism surveying rods.

2. Description of the Related Art

In conducting a land survey, a surveyor typically carries a global positioning system (GPS) rod or a standard prism rod from location to location to take measurements. Typically GPS rods include bulky electronic equipment and long antennas that are cumbersome to handle and store, especially when utilized in a surveying vehicle, the latter typically comprising a conventional pick-up truck. Usually, when traveling between locations, the surveyor must break down all of the equipment into various components and reassemble the same upon reaching the next survey location, resulting in lost time. Prior art efforts that have attempted to solve this shortcoming, such as telescoping rods that can be extended when used and compressed when traveling, have not resulted in significant savings in time. In this regard, and as is well known in the art, GPS units rely upon satellites to determine location, and require a “lock” on those satellites before reporting any information. When GPS antennas and receiver units are deconstructed for travel, such units need to be turned off, thus losing its lock on the satellites. After reaching a new location, a satellite lock is required to be re-established, which is known to be a time-consuming process. Similarly, problems are present when using conventional prism survey systems that require a visual connection back to a base station. In this regard, such systems typically utilize a pole that must be properly positioned to provide accurate surveying data; however, being able to quickly assemble such pole in the proper orientation is time consuming.

Moreover, to the extent such surveying equipment is simply left in position upon the surveying truck, the equipment can become damaged from the shock coming from the road. Alternatively, when stowed in the bed of the truck, the surveying equipment tends to bounce around, resulting in malfunctions.

These same drawbacks exist for practically all other types of surveying poles and related equipment, which thus adds substantial time and labor to surveying activities. Along these lines, it is well-known that dozens of surveying poles are routinely utilized in surveying practices, and that the ability to quickly deploy and store such poles presents an ongoing challenge and as such, there is a substantial need in the art for a device that can greatly facilitate the ability to deploy such surveying poles to thus enable the same to be quickly and easily utilized for their intended surveying purpose. There is also a need in the art for such a device that is of simple construction, relatively low cost to manufacture, can be utilized with virtually any type of surveying pole, and is capable of being utilized in combination with conventional pick-up trucks, as typically utilized in surveying tasks.

### BRIEF SUMMARY OF THE INVENTION

In light of the foregoing limitations, the present invention was conceived. Provided is an outrigger capable of vertically positioning a surveying rod for travel between multiple survey locations without disassembly and quick access to the same upon reaching a given survey location. In the case of a GPS surveying unit, a constant lock on satellites is maintained, and in the case of a conventional surveying unit, a visual connection to the base is maintained.

The outrigger includes an elongate outrigger support member having a stake pocket adapter, which is inserted into the stake pocket of a conventional truck to secure a connection. The stake pocket adapter is connected to the outrigger with an adapter plate of sufficient length to prevent the outrigger member from scratching the side surface of the truck. The outrigger member is further retained in position by a rope, which preferably comprises a bungee cord, that wraps around the outrigger member and hooks to the underside of the truck, preventing outward movement.

Preferably, three anchoring mechanisms are provided along the length of the outrigger member for use to secure a surveying rod. At the lowest end of the member, there is a plate having a hole where a surveying rod can be inserted. At the highest end, a rubber clamp grasps the surveying rod. The clamp has separation point in the middle so that an application of force will pull the two sides of the clamp apart, allowing the surveying rod to be removed or inserted. In the middle section are a plurality of plates sandwiching the surveying rod that, in combination with a rapidly removable wire lock pin, are operative to secure the surveying pole in secure vertical orientation.

### BRIEF DESCRIPTION OF THE DRAWINGS

FIG. 1 is an environmental perspective view of the surveying rod outrigger attached to a truck having a conventional stake pocket.

FIG. 2 is an orthogonal view of the surveying rod outrigger.

FIG. 3 is a side view of a surveying rod inserted into a stake receiver plate.

FIGS. 4a and 4b are top views of a pair of middle anchor plates securing a surveying rod.

FIGS. 5a and 5b are top views of an upper rod holder clamp.

### DETAILED DESCRIPTION OF THE INVENTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention.

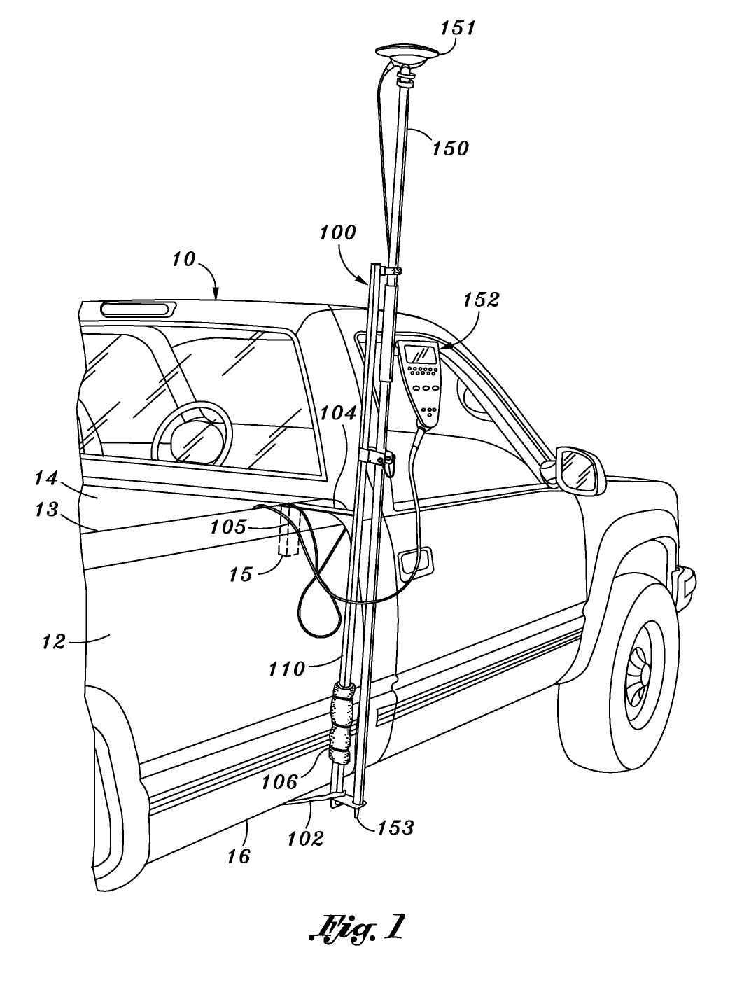

With reference now to FIG. 1, outrigger 100 holds surveying rod 150 vertically on the side of a vehicle 10. In a preferred embodiment, surveying rod 150 is of a GPS enabled type, with GPS antenna 151 and GPS surveying unit 152. However, the use of a GPS surveying rod here is by way of example only and not of limitation, and any type of surveying equipment having a unitary rod with stake end 153 may be utilized.

Vehicle 10 is preferably a pickup truck having a bed 14 formed by a vertical outer panel 12 and bed rail 13 having a horizontally elongate length of outer panel 12. Stake pocket 15 is a downward extending cavity with its opening on the top of bed rail 13. Stake pocket 15 is configured for stake pocket adapter 105 to be inserted and secured to the interior of truck bed 14, and is the primary mechanism by which outrigger 100 is attached to vehicle 10. One end of adapter plate 104 is attached to stake pocket adapter 105 and the other end of adapter plate 104 is attached to elongate outrigger member 110. Adapter plate 104 is of sufficient length to extend the position of outrigger 100 outwards from vehicle 10 to avoid contact with outer panel 12. The vertical attachment position of adapter plate 104 with respect to outrigger member 110 can be modified to conform to any variation of heights of vertical outer panel 12. Generally, adapter plate 104 is positioned in the middle section of outrigger member 110.

Outrigger 100 is secondarily anchored to vehicle 10 at its lower end with an elastic cord 102. Elastic cord 102 binds outrigger member 110 and hooks on to chassis underside 16 of vehicle 10, and prevents outrigger 100 from swinging outwards. The force of elastic cord 102, however, pulls outrigger member 110 against outer panel 12. In order to prevent scratches, cylindrical cushion 106 is placed on outrigger member 110 where the curvature of outer panel 12 and the force of elastic cord 102 would otherwise result in outrigger member 110 contacting and scratching outer panel 12.

As described in FIG. 2, elastic cord 202 attaches to the underside of the vehicle with elastic cord hooks 212a and 212b. In a preferred embodiment, elastic cord 202 is a conventional hooked bungee cord. However, it may also be any elastic fastening device such as a ratchet tie down strap or a rubber tie down strap. Rod stake receiver plate 201 prevents elastic cord 202 from sliding off outrigger member or support shaft 210, and enables elastic cord 202 to apply a downward and lateral force to outrigger support shaft 210 to prevent rotational movement along the axis perpendicular to that of the vehicle outer wall. Typically, rod stake receiver plate 201 is attached to the bottom of outrigger support shaft 210.

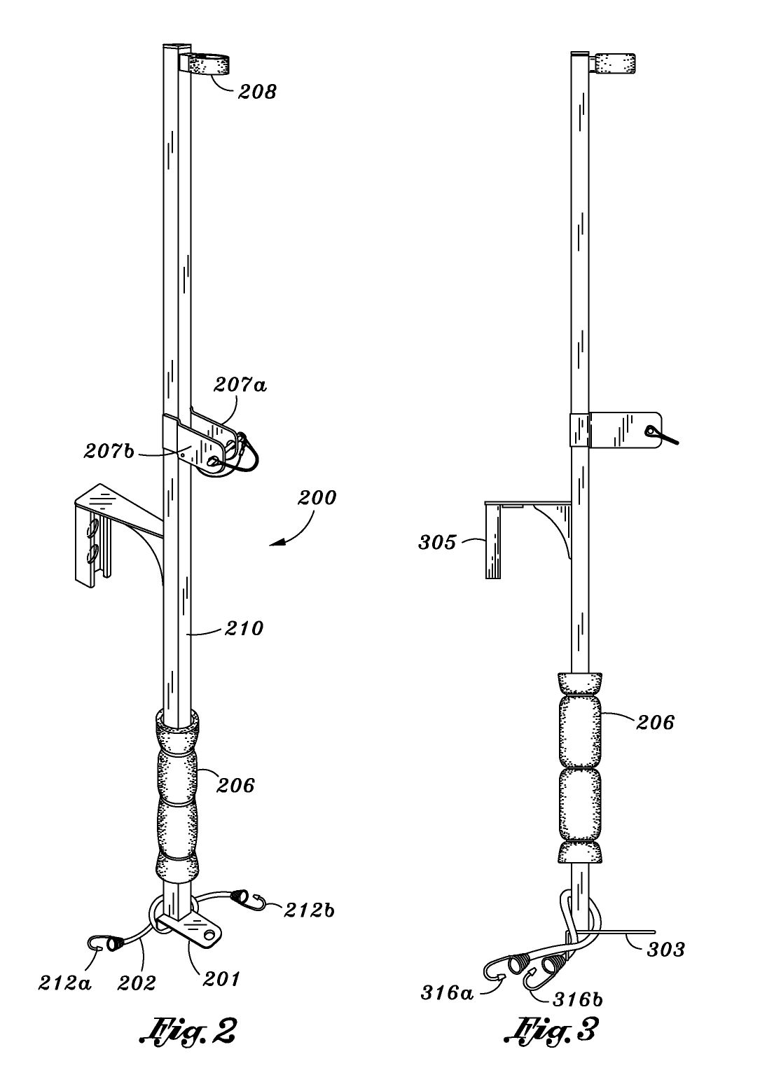

Rod stake receiver plate 301 of FIG. 3 includes stake securing hole 303, which functions as the first anchor point in which a surveying rod is secured to outrigger support shaft 310. The circumference of stake securing hole 303 is substantially less than the circumference of the main shaft portion 351 of surveying rod 350, but greater than the circumference of stake point 353. This configuration enables a section of stake portion 352 of surveying rod 350 to abut from stake securing hole 303 while preventing the entire surveying rod 350 from sliding through, thereby securing surveying rod 350 rod stake receiver plate 301 by gravitational force. Additionally, simple removal and insertion of surveying rod 350 is provided.

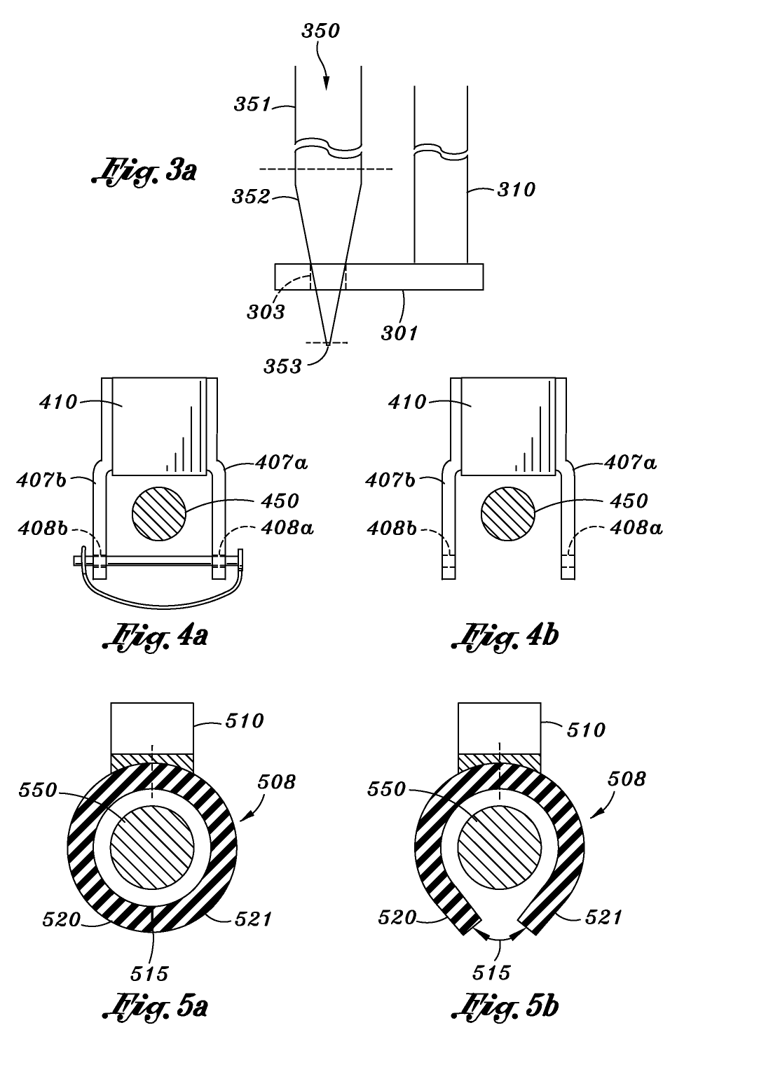

With reference again to FIG. 2, the second anchor point of the surveying rod is at middle anchor plates 207a and 207b, two identical members attached to opposite sides in the middle portion of elongate outrigger member 210, and extending in a parallel configuration along the same axis and direction away from outrigger support shaft 210 as rod stake receiver plate 201. Referring now to FIGS. 4a and 4b, middle anchor plates 407a and 407b include lock pin insertion holes 408a and 408b, respectively. Both lock pin insertion holes are positioned in substantially the same relative location, and are configured to receive a wire lock pin 407 that traverses lock pin insertion holes 408a and 408b and mechanically couples middle anchor plates 407a and 407b. As shown in FIG. 4a, surveying rod 450 is placed in the space defined by wire lock pin 407, middle anchor plates 406a and 406b, and outrigger support shaft 410, and its movement while stowage is limited therein. When wire lock pin 407 is removed, surveying rod 450 is easily removed as shown in FIG. 4b.

The use of wire lock pin 407 is one preferred embodiment for quickly releasing the hold of the second anchor point, but any number of fasteners may be utilized, for example, a clevis pin/cotter pin combination, or a tab-lock pin. Additionally, any number of other release mechanisms capable of quickly releasing a hold on surveying rod 450 may be utilized.

A third anchor point of the surveying rod is upper rod holder 208 of FIG. 2 located on the upper end of outrigger member 210. Detailed views of the upper rod holder are shown in FIGS. 5a and 5b, with two semicircular clamp element sections 520 and 521 connected to outrigger member 510. Upper rod holder 508 is constructed of semi-rigid material that permits flexing and separation at center opening 515, allowing surveying rod 550 to be easily removed when sufficient force is applied, as depicted in FIG. 5b. Without sufficient force, the two clamp elements remain in contact at center opening 515, and prevents surveying rod 550 from being removed, as shown in FIG. 5a.

In order to secure a surveying rod for travel, the following exemplary steps may be performed. First, with reference to FIG. 4a, wire lock pin 407 is removed from lock pin insertion holes 408a and 408b. Then, with reference to FIG. 3, stake point 353 is inserted into stake securing hole 303 at a slight angle, since upper rod holder 508 of FIG. 5 will hinder a fully upright position. The surveying rod is pushed into the clamp with sufficient force to overcome the elastic force keeping semicircular clamp elements 520 and 521 together. Now, the surveying rod is being held and supported at two extremities of the outrigger support shaft. Finally, as depicted in FIG. 4a, the wire lock pin 407 of is reinserted, ensuring that the surveying rod is prevented from shifting outside the constraints of wire lock pin 407, middle anchor plates 408a and 408b, and outrigger support shaft 410.

For removing the surveying rod upon reaching a destination, the reverse of the forgoing may be performed. Wire lock pin 407 shown in FIG. 4a is removed, and the surveying rod is pulled with sufficient force to overcome the elastic forces of semicircular clamp elements 520 and 521 of FIG. 5. The surveying rod is then lifted up and removed from stake securing hole 303 of FIG. 3.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

1. A surveying rod outrigger for use with a surveying rod having a main shaft portion defining a main shaft circumference and a stake point defining a stake circumference less than the main shaft circumference, the surveying rod outrigger adapted to a vertical outer panel of a truck bed having a stake pocket, a first and a second chassis underside eyelet, the surveying rod outrigger comprising:
a) an outrigger member defined by a shaft extending along a first axis, the outrigger member being disposable in a substantially parallel orientation relative to the vertical outer panel, the outrigger member having a proximal end, a distal end, and a middle section disposed therebetween;
b) a truck attachment member integrally formed with said middle section of said shaft and being insertable into said stake pocket of said truck;
c) a chassis connection cord having a first hooked end and a second hooked end disposed around said outrigger member at said proximal end of said shaft and said first hooked end being connectable to said first chassis underside eyelet and said second hooked end being connectable to said second chassis underside eyelet;
d) an upper surveying rod securing member extending along a second axis from said distal end of the outrigger member, the upper surveying rod being engageable with the surveying rod;
e) a middle surveying rod securing member extending along the second axis from said middle section of the outrigger member, the middle surveying rod securing member being engageable with the surveying rod; and
f) a rod stake receiving plate extending along the second axis from the proximal end of the outrigger member, the rod stake receiving plate being engageable with the surveying rod, the rod stake receiving plate defining an upper face, an opposing lower face and a stake receiving hole extending from the upper face to the lower face, the stake receiving hole defining a circumference being larger than the stake circumference and smaller than the main shaft circumference to allow the rod stake receiver plate to completely circumnavigate
a portion of the surveying rod when the rod stake receiving plate is engaged with the surveying rod.

2. The surveying rod outrigger as set forth in claim 1, wherein said truck attachment member includes a stake pocket adapter inserted into said stake pocket, and an adapter plate having an outrigger end connected to said shaft and a vehicle end connected to said stake pocket adapter.

3. The surveying rod outrigger as set forth in claim 1, wherein said truck attachment member extends the position of said shaft beyond contact with said vertical outer panel.

4. (canceled)

5. The surveying rod outrigger as set forth in claim 1, wherein middle surveying rod securing member includes a plurality of middle anchor plates extending along a second axis defining securing bolt insertion holes, said middle anchor plates attached to said middle section of said shaft, and a releasable securing bolt extending horizontally perpendicular to said second axis through said securing bolt insertion holes.

6. (canceled)

7. The surveying rod outrigger as set forth in claim 1, further comprising a cushion attached to proximal end of said shaft to prevent direct contact between said shaft and said vertical outer panel.

8. The surveying rod outrigger as set forth in claim 2, wherein the stake pocket adapter extends along an axis substantially parallel to the first axis.

9. The surveying rod outrigger as set forth in claim 1, wherein the upper surveying rod securing member is moveable between an open position and a closed position relative to the outrigger member, the upper surveying rod securing member completely circumnavigating the surveying rod when the upper surveying rod securing member is in the closed position and engaged with the surveying rod.

10. The surveying rod outrigger as set forth in claim 9, wherein the upper rod holder includes two semicircular clamp elements.

11. A surveying rod outrigger adapted to a vertical outer panel of a truck bed having a stake pocket, a first and a second chassis underside eyelet, comprising:
a) an outrigger member defined by a shaft extending along a first axis having a proximal end, a distal end, and a middle section disposed therebetween;
b) a truck attachment member integrally formed with middle section of said shaft and inserted into said stake pocket of said truck;
c) a rod stake receiver plate extending from said proximal end of said shaft along a second axis and defining a rod stake receiver hole disposed about a stake receiving axis; and
d) a rod stake receiving plate extending from the proximal end of the outrigger member, the rod stake receiving plate being engageable with the surveying rod, the rod stake receiving plate defining an upper face and a lower face and a stake receiving hole extending from the upper face to the lower face, the stake receiving hole defining a circumference being larger than the stake circumference and smaller than the main shaft circumference to allow the rod stake receiver plate to completely circumnavigate a portion of the surveying rod when the rod stake receiving plate is engaged with the surveying rod.

12. The surveying rod outrigger as set forth in claim 11, wherein said truck attachment member includes a stake pocket adapter inserted into said stake pocket, and an adapter plate having an outrigger end connected to said shaft and a vehicle end connected to said stake pocket adapter.

13. The surveying rod outrigger as set forth in claim 12, wherein the stake pocket adapter extends along an axis substantially parallel to the first axis.

14. The surveying rod outrigger as set forth in claim 11, further comprising a cushion attached to proximal end of said shaft to prevent direct contact between said shaft and said vertical outer panel.

15. The surveying rod outrigger as set forth in claim 11, further comprising an upper rod holder extending from the distal end of the outrigger member, the upper rod holder being moveable between an open position and a closed position relative to the outrigger member.

16. The surveying rod outrigger as set forth in claim 15, wherein the upper rod holder includes two semicircular clamp elements.

17. A surveying rod outrigger adapted to a vertical outer panel of a truck bed having a stake pocket, a first and a second chassis underside eyelet, the surveying rod outrigger configured for use with a surveying rod, the surveying rod outrigger comprising:
a) an outrigger member defined by a shaft extending along a first axis having a proximal end, a distal end, and a middle section disposed therebetween;
b) a truck attachment member integrally formed with middle section of said shaft and inserted into said stake pocket of said truck;
c) a rod stake receiver plate extending from said proximal end of said shaft along a second axis and defining an upper face, an opposing lower face, and a rod stake receiver hole extending from the upper face to the lower face and disposed about a stake receiving axis, the upper face and lower face being substantially perpendicular to the first axis, the rod stake receiver hole being sized to be circumferentially engagable with a portion of the surveying rod; and
d) an upper rod holder attached to said distal end of said shaft, the upper rod holder being disposed about the stake receiving axis.

18. The surveying rod outrigger as recited in claim 17 wherein the upper rod holder is sized to be circumferentially engageable with a portion of the surveying rod.

19. The surveying rod outrigger as set forth in claim 18, wherein the upper rod holder includes two semicircular clamp elements.

20. The surveying rod outrigger as set forth in claim 17, further comprising a chassis connection cord having a first hooked end and a second hooked end disposed around said outrigger at said proximal end of said shaft and said first hooked end connected to a first chassis underside eyelet and said second hooked end connected to a second chassis underside eyelet.
